(19) United States
(12) Patent Application Publication
(10) Pub. No.: US 2012/0191973 A1
(43) Pub. Date: Jul. 26, 2012

(54) ONLINE PRESENCE OF USERS

(75) Inventors: Sebastien Ardon, Darlinghurst (AU); Robert Hsieh, Singapore (SG); Aruna Seneviratne, Lane Cove (AU); Maximillian Ott, killara (AU)

(73) Assignee: NATIONAL ICT AUSTRALIA LIMITED, Eveleigh, NSW (AU)

(21) Appl. No.: 13/062,903

(22) PCT Filed: Sep. 10, 2009
(86) PCT No.: PCT/AU09/01188

§ 371 Date: Nov. 7, 2011

(30) Foreign Application Priority Data
Sep. 10, 2008 (AU) 2008904718

(51) Int. Cl. H04L 9/28

(52) U.S. Cl. 713/168

(57) ABSTRACT

The invention concerns presence of users, such as online presence in a broadcast domain. First one-way encrypted (e.g. hashed) presence information of multiple users is received (42) from their respective devices. Then for each received presence information, attempting to match (44) that received hashed presence information to a token of a stored set of tokens where each token corresponds to a user. The presence of a subset of the multiple users for which a matching token is in the stored set is determined, causing the generation (46) of an indication of the presence of one or more users of the subset of the multiple users. Aspects of the invention include methods, systems and software.

### TECHNICAL FIELD

The invention concerns presence of users. For example, but not limited to, the example concerns sharing presence information between users of an electronic network where the presence information can be online or offline. Aspects of the invention include a system, mobile device, software, presence signals and methods for sharing and determining presence of users on the same broadcast domain.

### BACKGROUND ART

Presence advertising concerns the sharing of presence information of users connected by their devices to a particular electronic network. That is, where software of various devices, such as laptops and mobile phones, which are connected to the same communications network are used advertise to other, devices in substantially real-time their online status, and also report on other users' online status.

By sending their presence advertisement the user is indicating that they are online and available for interactive communication. The online status of the user is typically one of several values, such as ‘online’, ‘offline’, ‘online but do not disturb’, or any other variation.

Presence advertisements are used in many Instant Messaging (IM) software applications such as Skype, and AOL Instant Messenger (AIM).

An IM application instance typically populates a ‘friends list’, which is a list of other users that utilise the same IM application and are known to the user of the application. This friends list is created by entering each user's identifier in the IM application either manually or as a result of a search. To be located in such a search, each users provides personal information that the search can be performed on so that others can identify them. Using presence advertising this friends list is updated in substantially real time to reflect the online status of the users in the friends list.

Typically, each user application instance reports their online status to a central point, such as a central server. All users check the central server to determine the current presence of the users in their friends list. This centralized nature introduces a single point of failure. When the central server is down, the online status information of all users cannot be reported or accessed. The network bandwidth required at the server to maintain each users information and access requests is also high per-user. Communication with the server can also incur additional cost to the end-users, such as 3G connectivity costs.

### SUMMARY OF THE INVENTION

In a first aspect the invention is a computer implemented method of determining the presence of users of the same broadcast domain comprising the steps of:
(a) on the broadcast domain, receiving one-way encrypted presence information of multiple users from their respective devices;
(b) for each received one-way encrypted presence information, attempting to match that received one-way encrypted presence information to a token of a stored set of tokens where each token corresponds to a user, and determining the presence of a subset of the multiple users for which a matching token is in the stored set; and
(d) generating an indication of the presence of one or more users of the subset of the multiple users.

It is an advantage of this aspect of the invention that the privacy of the users that are not in the subset is maintained as a device performing the method is unable to interpret their received presence information without matching it to a corresponding stored token. By not being able to interpret the presence information, the included personal/private information that uniquely identifies the other users/devices to indicate their presence, is not disclosed.

It is an advantage of at least one embodiment of the invention that a single device can determine the presence of other users without referring to a central server.

The method may further comprise the step of sending one-way encrypted presence information to the multiple users in the broadcast domain.

The presence information may indicate that the user sending the one-way encrypted presence information is currently connected to the broadcast domain (i.e. online).

The one-way encrypted presence information may identify the corresponding user that sent the hashed presence information. For example the one-way encrypted presence information may be based on any one or more of:
an email address,
a mobile phone number, and
an alternate phone number,
   such as a cryptographic hash of this information. One-way encrypted information is coded in a way that renders it unintelligible to the recipient. In this case a user is unable to decipher the underlying identification information as the encryption can not be inverted.

The method may be repeated at intervals and may further comprise generating an indication of updates to the presence information.

Each stored token is related to the identity of the corresponding user, such as information that identifies the corresponding user. The stored tokens may be automatically determined from a list of user identities stored locally on the device performing the method, the list including identification information for each user on the list from which the respective tokens can be determined. The stored tokens may be based on contact information listing people known to the user. The stored tokens may be determined by one-way encrypting user identification information stored in a list of users.

The one-way encrypted presence information may be matched by comparing a token to received presence information.

The indication information may be visual, audio and/or tactile. The step of generating an indication may include displaying a information that identifies each user in the subset.

In a broadcast domain all devices can transmit information to any other device using a medium that is a shared transmission system. The method may be performed by a mobile device having broadcasting abilities on the broadcast domain, that is sending and receiving broadcasts. The broadcast network may span a particular area, and the presence information may also indicate that the user is within the particular area. This proximity information may also be indicated.

The method may further comprise using the matched presence information of the subset of multiple users in a peer-to-peer file transfer, an instant messaging software application or other social networking software application. One example is populating a friends list on such an application with the subset of users.

In yet a further aspect the invention is software, installed in the device, to cause if to operate in accordance with the method described above.

In another aspect the invention provides a device for determining the presence of other users of the same broadcast domain, the device having:
broadcasting means to receive one-way encrypted presence information of multiple users from their respective devices on the broadcast domain;
a processor, for each received one-way encrypted presence information, to attempt to match that received one-way encrypted presence information to a token of a stored set of tokens where each token corresponding to a user, to determine the presence of a subset of the multiple users for which a matching token is in the stored set, and to generate an indication of the presence of one or more users of the subset of the multiple users; and
indication means to present to the user the indication of the presence of the one or more users of the subset of the multiple users.

In a further aspect the invention provides a presence signal sent in a broadcast domain to devices connected the broadcast domain, the presence signal indicating a user's presence on the broadcast domain and comprising a one-way encryption of identification information of the user.

In yet a further aspect, the invention provides a system for selectively sharing presence information between multiple devices, the system comprising:
a first device to send one-way encrypted presence information of a first user in the broadcast domain to a second and third device;
the second device to store tokens including a first token that corresponds to the identity of the first user, to receive the one-way encrypted presence information, and to match the one-way encrypted presence information to a stored token to determine the presence of the first user on the broadcast domain; and
the third device to store tokens but not including a token that corresponds to the identity of the first user, to receive the one-way encrypted presence information and to unsuccessfully attempt to match the one-way encrypted presence information to a stored token and is unable to determine the presence of the first user in the broadcast domain.

It is an advantage of at least one embodiment of the present invention that the mobile devices do not have to share a secret key for each user that would otherwise impair the users' experience. The only information they need to exchange is their unique identifier that is based primarily for use in another application, such as telephone number or email addresses. It is a further advantage of at least one embodiment that since no central server is required, the system does not require any new infrastructure.

### BRIEF DESCRIPTION OF THE DRAWINGS

Examples of the invention will now be described with reference to the accompanying drawings, in which:

FIG. 1 shows an example system of multiple devices that are used in this example;

FIG. 2 is a flow chart of the method performed by a single device that is used in this example;

FIG. 3 is a schematic representation of a presence component of a device of this example; and

FIG. 4 is a schematic representation of a user interface component of the device this example.

### BEST MODES OF THE INVENTION

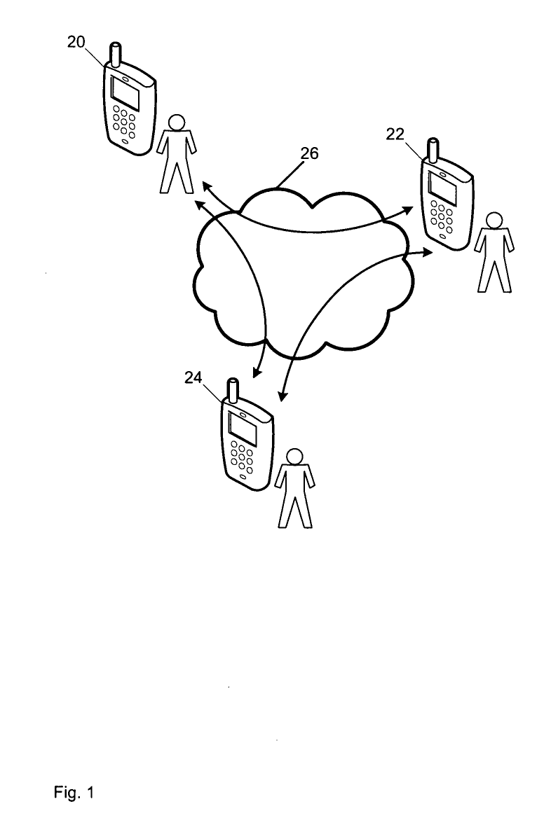

An example of a system for selectively sharing presence information between multiple devices is shown in FIG. 1. Here there are three devices 20, 22 and 24 that are mobile phones.

Each mobile phone 20, 22 and 24 has the following:
a unique mobile telephone number;
an indication means, such as a touch screen, that is able to display a user interface;
input means, such as buttons or the touch screen;
storage means, such as internal RAM, that stores a list of users previously known to the user of the mobile phone, such as a contact list containing mobile numbers and corresponding user names;
connection means, such a WiFi (802.11) radio transceivers (i.e. having an input and output port) capable of broadcasting capability, such as 802.11 or g-compliant radio transceivers; and
a processor and software, such as a client application, to cause the mobile to operate in accordance with the example described here.

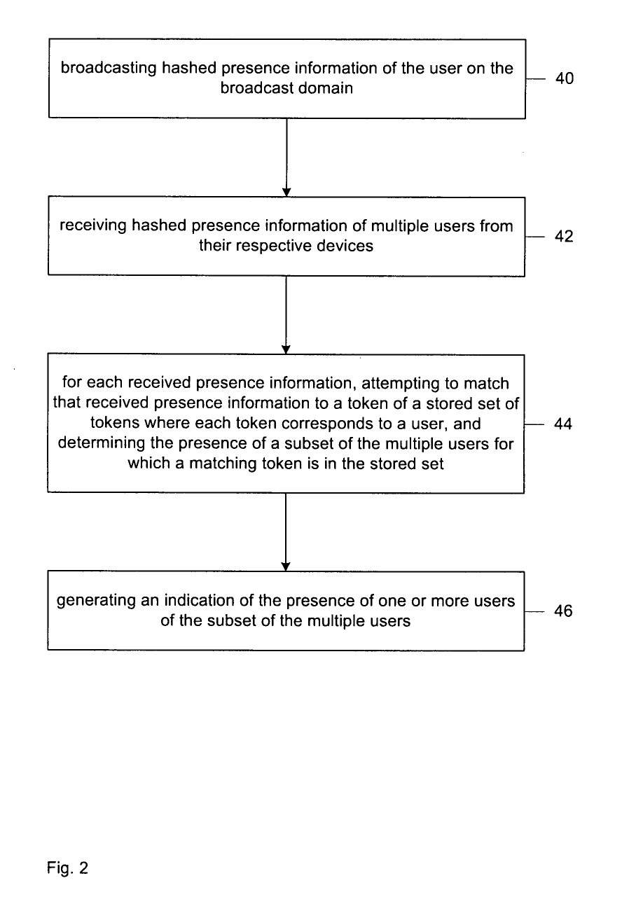

The use of these mobile phones 20, 22 and 24 to determine their presence on the same broadcast network 26 will be described with reference to the flowchart of FIG. 2. In this example, the users of mobile phone 20 and 22 are already known to each other and they have each other's mobile number stored in their contact list (i.e. electronic address book). This contact list is usually used on each mobile phone to easily locate numbers and dial them without having to enter them in each time they are needed. The mobile phone number of the mobile phone 24 is not stored on the mobile phones 20 and 22, and neither is the mobile numbers of the phones 20 and 22 stored in the contact list of the mobile phone 24.

The mobile phones 20, 22, and 24 are positioned in the same vicinity, such as a shopping centre, and are all connected to the same WiFi local area network 26.

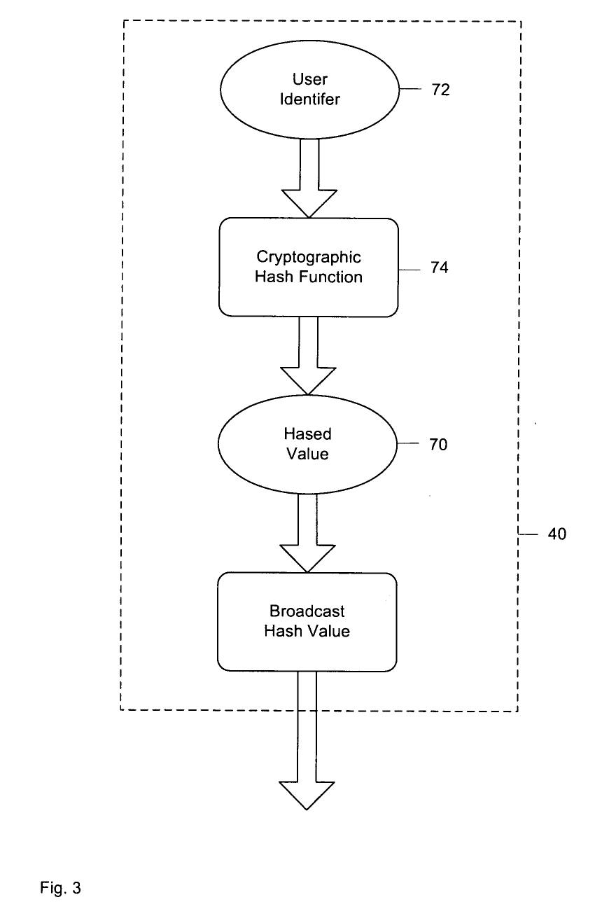

Each mobile phone 20, 22 and 24 periodically broadcasts 40 presence information (i.e. presence message M) on this WiFi local area network 26. This is done using a presence advertiser component shown in FIG. 3. The presence message M contains a one-way encrypted, e.g. cryptographic hash, 70 of a unique identifier 72 associated with the mobile phone, which in this case is the mobile number of the corresponding mobile phone. This unique identifier 72 is converted using a one-way secure hash function 74, such as SHA-1 [1].

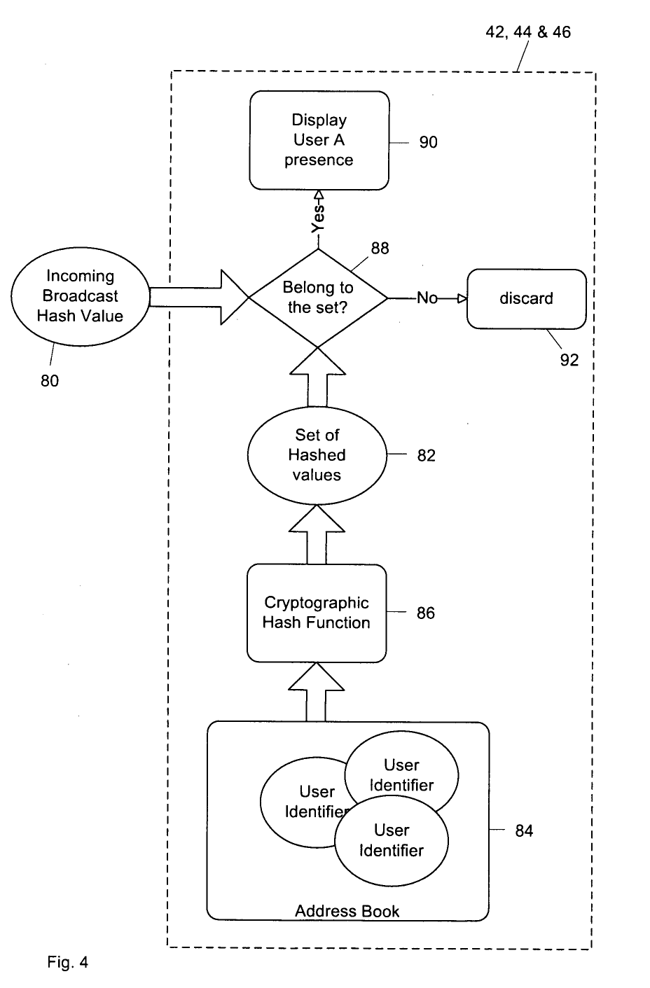

Each mobile phone receives 42 the hashed presence messages sent by the other two mobile phones on the broadcast domain. Interpretation of these received presence messages 80 is performed by the user interface component shown in FIG. 4.

Each mobile phone stores a set of hash values S (i.e. set of tokens) 82. This set is built by taking each unique mobile phone number recorded in that mobile device's contact list 84, and hashing 86 each mobile phone number 84 and storing it in the set S 82. So in this example, mobile phone 22 has a hash value mobile number of mobile phone 20 but not a token for the mobile number of mobile phone 24. Since mobile phone 24 does not have the mobile number of mobile phone 20, stored in its contact, list, no hash value corresponding to mobile phone 20 is stored on the mobile phone 24.

In this example, when the mobile phone 22 receives a presence message M which was sent by mobile 20, it checks 88 if the hash value contained in M belongs to the set S 44. This checking step can be performed by:
Iteratively by comparing the received hash M successively with each hash value in S
By using a Bloom Filter data structure, for more efficiency in the case of large number of mobile phone numbers in the contact list
Using other set membership test procedures

In this case mobile phone 22 finds a match, so the presence information is confirmed, and an indication of this is generated. In this example, the details of the user associated with the mobile phone number 20 of the presence message, such as their name as recorded in the contacts list, is displayed 46 on the display of the mobile device 22 together with an indication that the user of mobile phone 20 is online 90. Of course, if the mobile phone 22 has received and successfully matched presence information of other mobile phone users to tokens, they are also simultaneously displayed on the display of the mobile phone 22.

When the mobile phone 22 receives a presence message M which was sent by mobile 24, it checks 88 if the hash value contained in M belongs to the set S 44. In this case it doesn't so the mobile phone 22 is unable to determine the presence of user of mobile 24. In this way the mobile phone 22 is able to determine the presence of a subset (i.e. 20) of the multiple users (i.e. 20 and 26) that sent presence messages.

This online presence status can then be used by the mobile device 22 using a proximity-based mobile social networking application or a peer-to-peer file transfer application over the local area network 26.

In the case of mobile phone 24, no match 88 is found and the mobile phone 24 does not take any action 92. The mobile phone 24 is therefore unable to determine the mobile phone number of the mobile phone 20 that was included in the received presence message.

The broadcast domain of this example spans over a small to medium geographical area. In this example, the presence advertisement also implies that the user of that mobile device is in physical proximity to the receiving mobile phone. In this case, the online presence of that user that is displayed on the display means also displays (either explicitly or implicitly) that the other mobile phone is in physical proximity to the displaying mobile device.

It is an advantage of this example that no special hardware requirements such as a central server is needed to implement the invention. By having no central server there are also less privacy concerns. Also, the users' experience in using the invention requires very small set up. For example the devices of each user needs to have installed a simple software application. The users do not need to exchange special keys to determine their presence privately. In future, they can simply rely on their existing stored contact list.

It will be appreciated by persons skilled in the art that numerous variations and/or, modifications may be made to the invention as shown in, the specific embodiments without departing from the scope of the invention as broadly described.

For example, the presence signal can be used to automatically populate a ‘friends list’ in a social networking application, such as an instant messenger application. This avoids the need to manually enter contacts into a ‘friends list’.

Alternatively, the presence information can be used in a mobile peer-to-peer file transfer application and to map a user identifier with an IP address, i.e. a network service point of contact. The knowledge of the IP address is necessary to initiate a file transfer or an Instant Message, or any other form of point-to-point IP communication.

In addition, this invention can be used to filter out unknown user's advertisement from the buddy list, to only display users present in the phone address book, and (presumably) known to the user. This solves the problem encountered by Bluetooth users when wanting to send a file to a nearby device, but swamped by the large number of ‘discoverable’ Bluetooth devices in the communication range.

The terminal's contact list can be the terminal address book content, or calendaring or any other list of contacts.

Can be used together with an authentication scheme such as a 2-factor authentication methods (e.g. SIM CARD authentication in mobile phones AND a password-authenticated form of diffie-helman key exchange).

The present embodiments are, therefore, to be considered in all respects as illustrative and not restrictive.

### REFERENCES

[1] FIPS 180-2: Secure Hash Standard (SHS)—Current version of the Secure Hash Standard (SHA-1, SHA-224, SHA-256, SHA-384, and SHA-512), 1 Aug. 2002, amended 25 Feb. 2004

1. A method of determining the presence of users of the same broadcast domain comprising the steps of:
(a) on the broadcast domain, receiving one-way encrypted presence information of multiple users from their respective devices;
(b) for each received one-way encrypted presence information, attempting to match that received one-way encrypted presence information to a token of a stored set of tokens where each token corresponds to a user, and determining the presence of a subset of the multiple users for which a matching token is in the stored set; and
(c) generating an indication of the presence of one or more users of the subset of the multiple users.

2. The method according to claim 1, wherein the method further comprises the step of broadcasting one-way encrypted presence information to the multiple users on the broadcast domain.

3. The method according to claim 1, wherein the one-way encrypted presence information is based on any one or more of:
an email address,
a mobile phone number, and
an alternate phone number.

4. The method according to claim 1, wherein the method is repeated at intervals and further comprises generating an indication of updates to the presence information.

5. The method according to claim 1, wherein each stored token is related to the identity of a user.

6. The method according to claim 5, wherein the stored tokens are determined by one-way encrypting user identification information stored in a list of users.

7. The method according to claim 1, wherein the indication information is one or more of visual, audio and tactile.

8. The method according to claim 1, wherein the broadcast network spans a particular area, and the presence information also indicates that the user is within the particular area.

9. The method according to claim 1, wherein the method is performed by a mobile device having broadcasting abilities on the broadcast domain.

10. Software installed on a device having broadcasting abilities on the broadcast domain, to cause it to operate in accordance with the method of claim 1.

11. A device for determining the presence of users of the same broadcast domain, the device having:
broadcasting means to receive one-way encrypted presence information of multiple users from their respective devices on the broadcast domain;
a processor, for each received presence information, to attempt to match that received one-way encrypted presence information to a token of a stored set of tokens where each token corresponds to a user, to determine the presence of a subset of the multiple users for which a matching token is in the stored set, and to generate an indication of the presence of one or more users of the subset of the multiple users; and
indication means to present to the user the indication of the presence of the one or more users of the subset of the multiple users.

12. A presence signal sent in a broadcast domain to devices connected to the broadcast domain, the presence signal indicating a user's presence on the broadcast domain and comprising a one-way encryption of information that identifies the user.

13. A system for selectively sharing presence information between multiple devices, the system comprising:
a first device to send one-way encrypted presence information of a first user in the broadcast domain to a second and third device;
the second device to store tokens including a first token that corresponds to the identity of the first user, to receive the one-way encrypted presence information, and to match the one-way encrypted presence information to a stored token to determine the presence of the first user in the broadcast domain; and
the third device to store tokens but not including a token that corresponds to the identity of the first user, to receive the one-way encrypted presence information and to unsuccessfully attempt to match the one-way encrypted presence information to a stored token and is unable to determine the presence of the first user in the broadcast domain.
